(19) United States
(12) Patent Application Publication
(10) Pub. No.: US 2009/0279745 A1
(43) Pub. Date: Nov. 12, 2009

(54) Method and System for Image Resolution Improvement of Biometric Digit Imprint Sensors Using Staggered Rows

(75) Inventor: Christian Liautaud, Boca Raton, FL (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Sonavation, Inc., Palm Beach Gardens, FL (US)

(21) Appl. No.: 12/117,486

(22) Filed: May 8, 2008

(51) Int. Cl. G06K 9/28

(52) U.S. Cl. 382/116

(57) ABSTRACT

Provided is a method of arranging a plurality of sensor elements to form a sensor array. The method includes arranging the plurality of elements to form two or more sub-rows along an axis. Elements in a first of the two or more sub-rows are positioned in a staggered arrangement with the elements in a second of the two or more sub-rows.

### BACKGROUND OF THE INVENTION

1. Field of the Invention

The present invention relates to biometric sensing. More particularly, the present invention relates to capturing a biometric imprint using one or more sensor arrays.

2. Background Art

Conventional biometric imprint devices, such as fingerprint sensors, include at least one sensor array. The sensor array includes a plurality of sensing elements usually positioned in an orthogonal arrangement of rows and columns. In these conventional sensor arrays, the size of the sensing element and the distance (pitch) between sensing elements, is determined by a required fingerprint resolution.

For example, the Federal Bureau of Investigation (FBI) requires 500 dots per inch (dpi) of resolution for fingerprint sensor arrays. Therefore, the pitch between each of the sensing elements in the sensor array must respect this 500 dpi requirement. A requirement of 500 dpi translates to 0.002 inches between each of the sensing elements. That is, if a sensor array is to meet the 500 dpi requirement, the pitch between individual sensors cannot exceed 0.002 inches.

In conventional sensor arrays that use traditional sensors, the pitch dictates the size of the sensors. That is, with all things being equal, a higher pitch will necessitate a smaller sensor. The smaller the sensor, the greater its cost due to challenges in manufacturability.

What is needed, therefore, are systems and method to increase the effective resolution of a captured biometric imprint, such a fingerprints. More specifically, what is needed are systems and methods to increase the pitch between sensing elements while, at the same time, increasing the effective resolution of the corresponding sensor array.

### BRIEF SUMMARY OF THE INVENTION

Consistent with the principles of the present invention, as embodied and broadly described herein, the present invention includes a method of arranging a plurality of sensor elements to form a sensor array. The method includes arranging the plurality of elements to form two or more sub-rows along an axis. Elements in a first of the two or more sub-rows are positioned in an interspersed or staggered arrangement with the elements in a second of the two or more sub-rows.

The present invention provides a unique technique for achieving a higher sensing array resolution with greater distances between sensing elements. The greater distances between sensing arrays, which can also translate into larger sensors, facilitate the construction of cheaper sensor arrays because fewer sensors will be required. Additionally, larger sensors are easier to manufacture. For example, an exemplary embodiment of the present invention enables the construction of sensing elements that are 41% larger than conventional sensors. These larger sensors, however, are still capable of meeting specified resolution requirements.

Further embodiments, features, and advantages of the present invention, as well as the structure and operation of the various embodiments of the present invention are described in detail below with reference to accompanying drawings.

### BRIEF DESCRIPTION OF THE DRAWINGS/FIGURES

The accompanying drawings illustrate the present invention and, together with the description, further serve to explain the principles of the invention and to enable one skilled in the pertinent art to make and use the invention.

FIG. 1 is an illustration of a conventional sensor array;

FIG. 2 is an illustration of a finger moving across the conventional sensor array of FIG. 1;

FIG. 3 is an illustration of a sensor array constructed and arranged in accordance with an embodiment of the present invention;

FIG. 4 is an illustration of combining multiple sub-frames to create a single frame achieving a required resolution in accordance with an embodiment of the present invention;

FIG. 5 is a block diagram illustration of a fingerprint system with improved resolution through staggering sensing element rows in accordance with the present invention; and

FIG. 6 is an illustration of an exemplary method of practicing an embodiment of the present invention.

The present invention will now be described with reference to the accompanying drawings. In the drawings, like reference numbers generally indicate identical, functionally similar, and/or structurally similar elements. The drawing in which an element first appears is indicated by the leftmost digit(s) in the reference number.

### DETAILED DESCRIPTION OF THE INVENTION

This specification discloses one or more embodiments that incorporate the features of this invention. The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to affect such feature, structure, or characteristics in connection with other embodiments whether or not explicitly described.

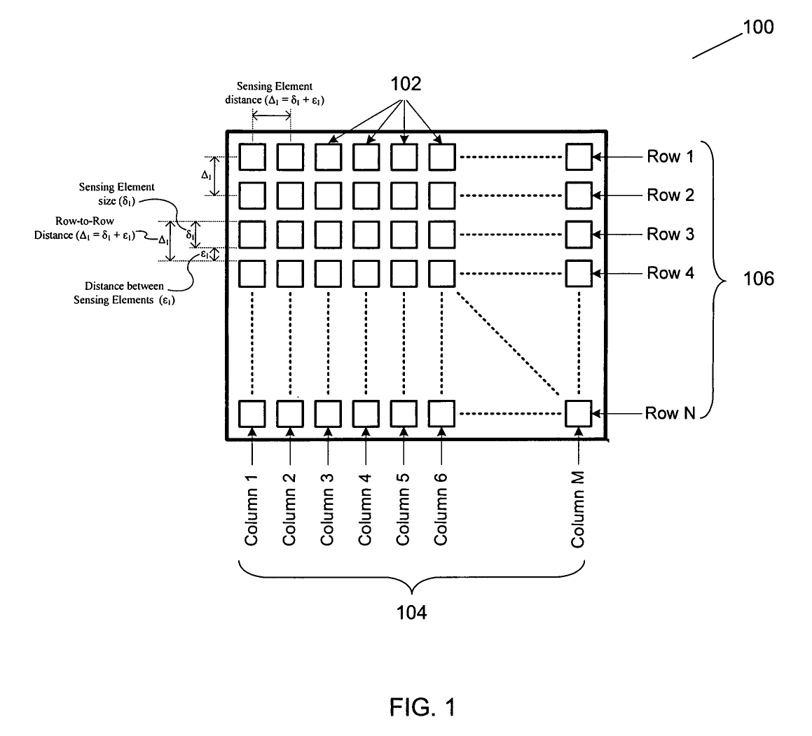

FIG. 1 is an illustration of a conventional sensor array 100. The sensor array 100 includes sensing elements 102, orthogonally positioned in an arrangement of M columns 104 and N rows 106. Most conventional sensor arrays include trenches or channels between each of the elements for manufacturability. Ideally, one would want that channel width to be zero, so that the sensing element is large as possible. In other words, it is desirable that the sensing elements be as large as possible for purposes of manufacturability and potential increased sensitivity. Within the conventional sensor array 100, a single frame capture will contain every pixel required for the targeted resolution.

More specifically, as shown in FIG. 1, a distance between sensing elements within the same row is denoted as Δ₁. This distance Δ₁ is derived from the desired fingerprint image resolution in an X (vertical) direction. In the example mentioned above, Δ₁ would represent the distance of 0.002 inches between sensing elements within the same row.

Similarly, the distance Δ₁ is also a measure of the distance between consecutive rows. The distance between consecutive rows Δ₁, as is the sensor size, is also determined by the desired fingerprint image resolution but in the Y (horizontal) direction. Most fingerprint agencies, such as the FBI, require that the X and Y resolutions be the same. Therefore, the distance between consecutive rows is also Δ=0.002 inches per rows of sensing elements. The distance of 0.002 inches equates to 50.8 micro-meters (μm). As also shown in FIG. 1, the quantity Δ₁ is a combination of δ₁ (size of an individual sensing element) and ε₁ (distance between the sensing elements).

The distance Δ₁ between sensing elements in a row, and between rows limits the size of the sensing element. For example: a device having the 500 dpi requirement (in both X and Y directions) will have a sensing element that is 0.002×0.002 inches at the most (50.8×50.8 μm). In reality, most sensors are actually slightly smaller than the 50.8×50.8 μm size because manufacturing requires a non-sensing channel between these sensing elements. Ultimately, however, if a greater distance Δ between sensing elements could be achieved, while still meeting the required resolution, manufacturability could be increased and sensor array costs could be reduced.

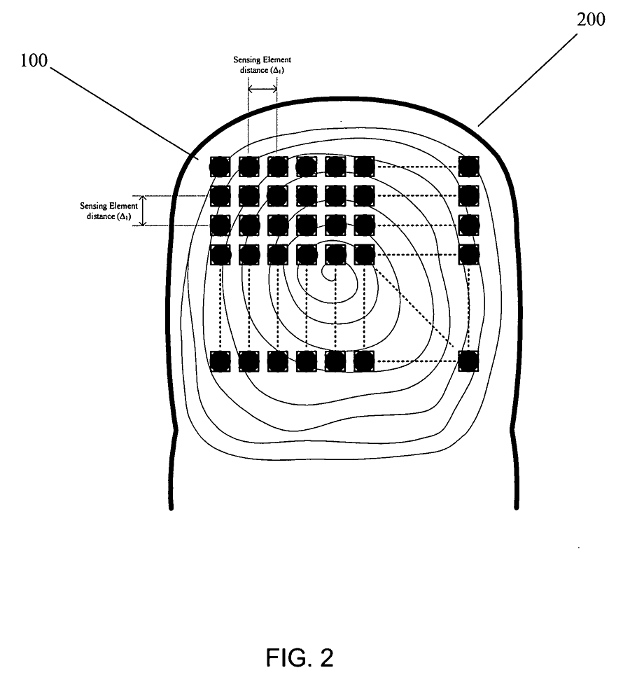

FIG. 2 is an illustration of a finger 200 positioned on the conventional sensor array 100, illustrated in FIG. 1. Generally, in cases where a finger (or other biometric digit) is swiped across a sensor array, all of the data required to meet the resolution requirement is captured within that single frame. That is, if there is a 500 dpi requirement, each piece of data needed to satisfy the 500 dpi requirement is captured within a single frame or swipe. Although the illustrations used in connection with the present invention are representative of a swipe sensor, the present invention is equally applicable to an aerial sensor, or other similar biometric imprint capture device.

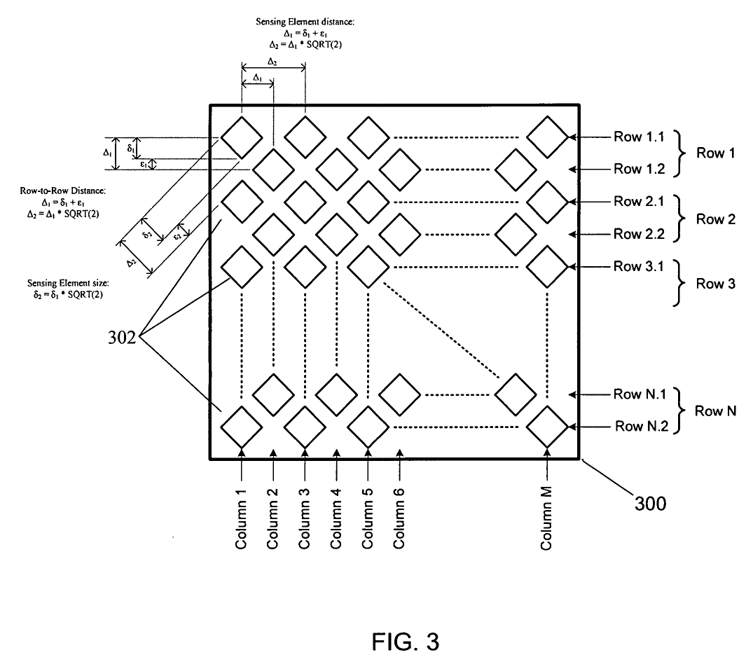

FIG. 3 is an illustration of a sensor array 300 constructed and arranged in accordance with an embodiment of the present invention. The sensor array 300 includes sensing elements arrayed in rows, where the rows are arranged in a staggered manner to increase the effective resolution of a captured fingerprint. In the sensor array 300, the staggered arrangement enables a greater distance Δ between sensing elements, thus increasing manufacturability.

In the exemplary embodiment of FIG. 3, each row of sensing elements is comprised of two or more sub-rows. In FIG. 3, for example, sensing elements within the array 300 are arranged in rows 1-N and columns 1-M. Each of the rows 1-N includes two sub-rows. For example, Row 1 includes sub-rows 1.1 and 1.2. Row 2 includes sub-rows 2.1 and 2.2, and so on. Although two sub-rows are shown in FIG. 3 for purposes of illustration, any other suitable number of two or more sub-rows could be used.

In FIG. 3, however, two sub-frames must be captured in order to create a complete frame having the required resolution. That is, information from two sub-rows (e.g., Row 1.1 and Row 1.2) is grouped together to construct a frame that meets the required resolution of a single complete row. The number of frames required corresponds to the number of sub-rows per effective rows.

Additionally, in the sensor array 300 of FIG. 3 the sensing elements are rotated 45 degrees with respect to traditional sensor placement. In FIG. 3, the quantity Δ₂ represents a distance (pitch) from one sensing element to another sensing element. Also in FIG. 3, the quantity Δ₁ represents the distance between sensing elements from one sub-row to the next sub-row (e.g., between sub-row 1.1 and the sub-row 1.2). As can be seen, the pitch Δ₂ is larger than the pitch Δ₁.

More specifically, in FIG. 3, the pitch Δ₂ is related to pitch Δ₁ by a factor of the square root of 2. In terms of relative sensor size, this means that the Δ₂ is larger than Δ₁ by about 41%. In short, by using the staggered arrangement of the sensor array 300, the distance between sensor elements is 41% greater than in the conventional sensor array. This advantage is provided primarily by orientation and distance between sensing elements, as illustrated in FIG. 3.

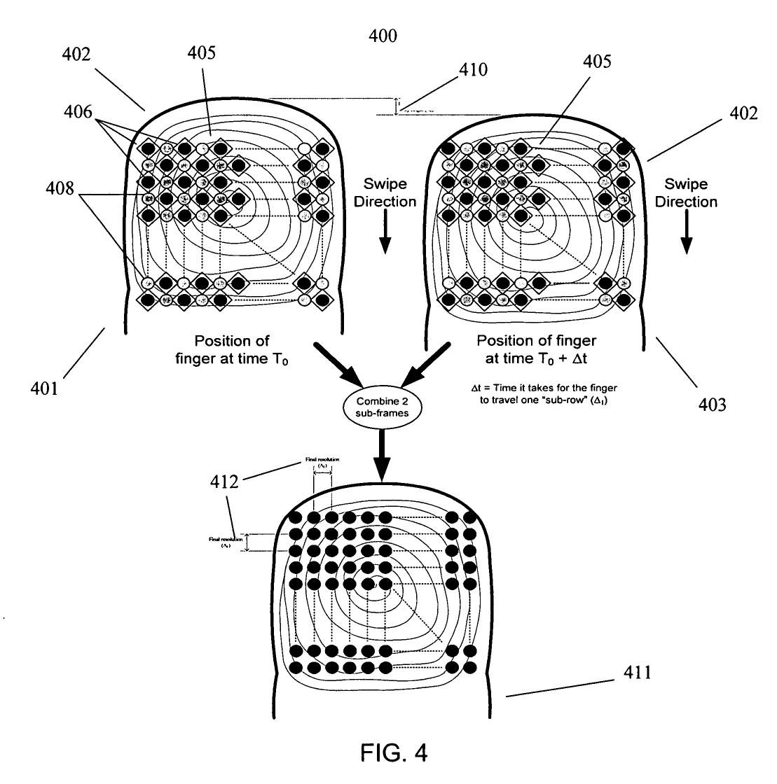

FIG. 4 is an illustration 400 of combining two separate sub-frames to create a single frame achieving a required resolution, in accordance with an embodiment of the present invention. In the illustration 400 of FIG. 4, a first sub-frame 401 is captured as a finger 402 is swiped across a staggered sensor array 405 at a time T₀. During the time T₀, all of the black dots, such as the black dots 406, are captured. All of the gray holes, such as the holes 408, represent all the data that is missing to form a complete row.

By the time the finger 402 has moved from one sub-row to the next, at a distance 410 of Δ₁, the next frame to fill in the blanks that were lacking from the first sub-row above, are captured during a second sub-frame 403 at time T₀+Δt. Ultimately, as shown below, the data captured from the first sub-row (at T₀) is combined with the data captured from a second sub-row at T₀+Δₜ to form an entire row. All of the sub-rows are then combined to form a complete frame 411. The complete frame 411 represents completed fingerprint that achieves the required resolution 412.

In the case where the sensor array height is such that multiple frames are required to reconstruct the whole fingerprint, the capture interval between sub-frames could be n*Δt. Where n is any number from 1 up to ½ the height of the sensor array. This will guarantee a minimum of 50% overlap between sub-frames. This also guarantees that all missing data from each sub-frame (grey holes) will be filled with data from the previous and/or next sub-frames. An interpolation algorithm in the time, frequency, or frequency-phase domain could be used to fill-in the missing data.

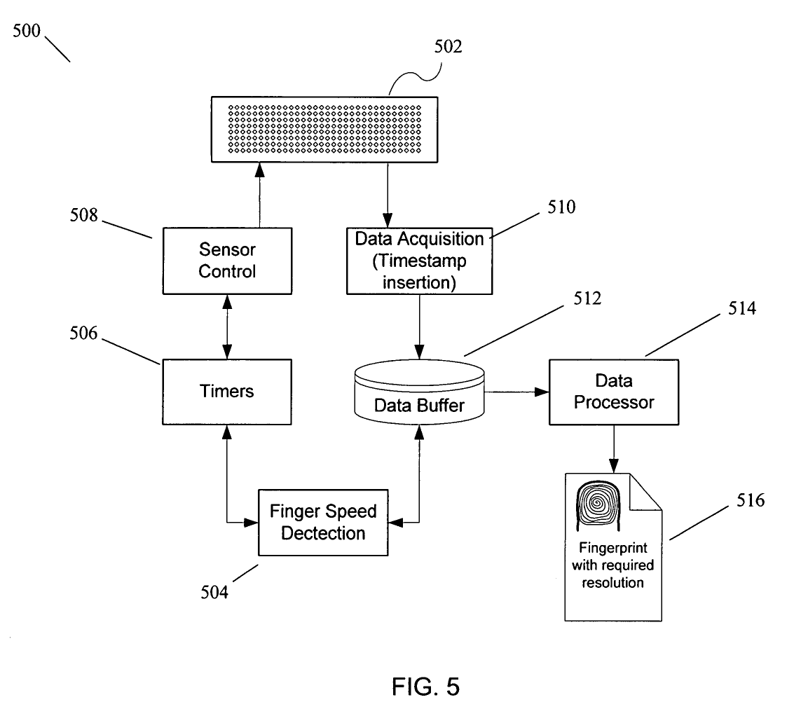

The timing difference (Δt) between the two captured sub-frames 401 and 403 is the time it takes for the finger to travel one or multiple sub-rows. This timing difference is a function of the travel speed of the finger. Thus, it is desirable that an image imprint system that embodies the sensor array 405 be able to determine the finger's swipe speed. As known in the art, finger swipe speed can be determined through a number of different techniques. The system of FIG. 5 is an illustration of one such technique.

More particularly, FIG. 5 is a block diagram illustration of a fingerprint system 500 capable of determining the swipe speed of a finger. The system 500 includes a fingerprint swipe sensor 502, along with a speed detection mechanism 504 to measure finger speed across the sensor 502. A timer 506 is included to set times required to capture the required sub-frames to construct an entire frame. A sensor control device 508 is also included in the system 500 to control operation of the sensor 502. The actual speed of the finger is determined as speed related data is acquired via a data acquisition device 510. The data acquisition device 510 inserts a record of time, or time stamp, for each, or a portion of, the data captured which could then be used to determine the speed of the finger. After the speed related data is acquired, it is then stored in a data buffer 512. The data from the data buffer 512 is also used by a data processor 514 to produce a fingerprint 516 having the required resolution.

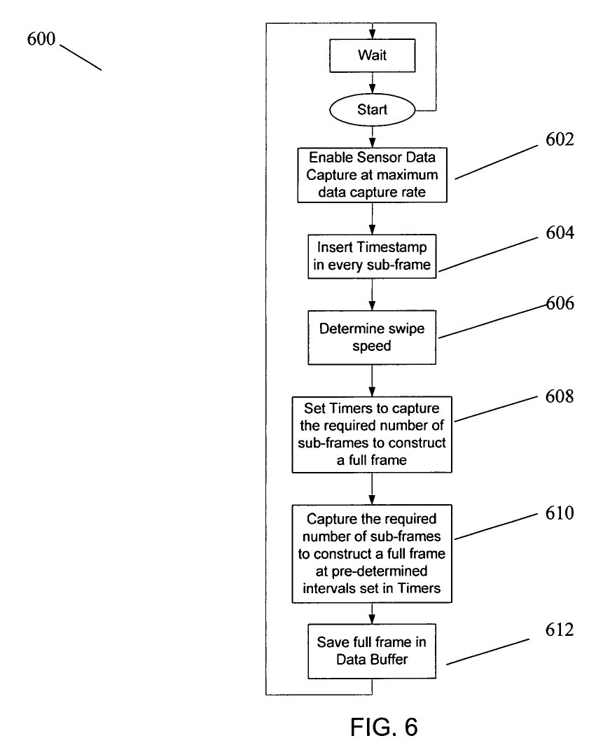

FIG. 6 is an illustration of an exemplary method 600 of practicing an embodiment of the present invention. In FIG. 6, for example, a sensor data capture mechanism is enabled for data capture at a maximum rate 602. A record of time, or timestamp, is inserted to go along with the data in step 604. Speed of the finger is then determined at a step 606. At step 608, timers are set to capture the required number of sub-frames to construct a full frame. The required number of sub-frames is then captured to construct a full frame at pre-determined intervals, which is established within the timers, in step 610. In step 612, a full frames worth of data is stored in a data buffer for reproducing an image of the fingerprint.

### CONCLUSION

Example embodiments of the methods, systems, and components of the present invention have been described herein. As noted elsewhere, these example embodiments have been described for illustrative purposes only, and are not limiting. Other embodiments are possible and are covered by the invention. Such other embodiments will be apparent to persons skilled in the relevant art(s) based on the teachings contained herein. Thus, the breadth and scope of the present invention should not be limited by any of the above described exemplary embodiments, but should be defined only in accordance with the following claims and their equivalents.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method of arranging a plurality of sensor elements to form a sensor array, comprising:
arranging the plurality of elements to form two or more sub-rows along an axis;
wherein the elements in a first of the two or more sub-rows are positioned in a staggered arrangement with the elements in a second of the two or more sub-rows.

2. The method of claim 1, wherein groups of corresponding elements form columns of the sensor element array.

3. The method of claim 1, wherein output data from the first of the two or more sub-row elements is combined with output data from the second of the two or more sub-row elements to form a data frame.

4. The method of claim 3, wherein the data frame is representative of segments of a biological surface along the axis.

5. The method of claim 4, wherein the surface is at least one of a fingerprint and a palm-print.

6. The method of claim 4, wherein the segments are substantially continuous along the axis.

7. The method of claim 4, wherein a distance between the segments is substantially zero.

8. The method of claim 4, wherein a rate of the combining is a function of at least one of speed and acceleration of movement of the biological surface across the array.

9. A sensor array, comprising:
a plurality of sensor elements combined to form two or more sub-rows along an axis of the array;
wherein the elements in a first of the two or more sub-rows are positioned in a staggered arrangement with the elements in a second of the two or more sub-rows.

10. The sensor array of claim 9, wherein groups of corresponding elements form columns of the sensor element array.

11. The sensor array of claim 9, wherein output data from the first of the two or more sub-row elements is configured to be combined with output data from the second of the two or more sub-row elements to form a data frame.

12. The sensor array of claim 11, wherein the data frame is representative of segments of a biological surface along the axis.

13. The sensor array of claim 12, wherein the surface is at least one of a fingerprint and a palm-print.

14. The sensor array of claim 12, wherein the segments are substantially continuous along the axis.

15. The sensor array of claim 12, wherein a distance between the segments is substantially zero.

16. The sensor array of claim 11, wherein a rate of the combining is a function of at least one of speed and acceleration of movement of the biological surface across the array.
